(19) United States
(12) Patent Application Publication
(10) Pub. No.: US 2003/0145635 A1
(43) Pub. Date: Aug. 7, 2003

(54) Book security device

(76) Inventor: Richard Myron Sheslow, Seven Hills (AU)

Correspondence Address: LARSON & TAYLOR, PLC, 1199 NORTH FAIRFAX STREET, SUITE 900, ALEXANDRIA, VA, 22314, US

(21) Appl. No.: 10/296,060

(22) PCT Filed: May 22, 2001
(86) PCT No.: PCT/AU01/00593

(30) Foreign Application Priority Data
May 22, 2000 (AU) PQ 7660

(51) Int. Cl. E05B 65/00; G08B 13/14

(52) U.S. Cl. 70/57.1; 340/572.9; 70/58

(57) ABSTRACT

A security device (10) for books comprising a receptor (20) adapted to fit behind the spine of a book, a connector flap (30) adapted to be secured to the receptor and to locate between and parallel with the pages of the book, and means (50) to lock the connector flap (30) to the receptor (20) to entrap the book.

### INTRODUCTION

This invention relates to a security device for books and especially relates to a lockable device that can be attached to books to reduce the likelihood of theft from book stores.

### BACKGROUND OF THE INVENTION

Shoplifting is a problem world over and recent trends have shown an extension of shoplifting into the fields of CDs, tapes, video tapes and books both in hard copy and paperback form. It is extremely difficult to monitor the theft of books especially small paperback books from stores, book stores and kiosks.

The device that is the subject of this invention is a potential solution to this problem.

### SUMMARY OF THE INVENTION

According to the present invention there is provided a security device for books comprising a receptor adapted to fit behind the spine of the book and a connector flap pivotably secured to the receptor and adapted to locate between and in parallel with pages of the book, and means to lock the connector flap to the receptor to entrap the book.

Preferably the means to lock comprises enclosures formed on the receptor and connector flap adapted to abut one another when the device is locked, the enclosures having resilient engagement means adapted to snap into locked engagement with a fixed detent when the receptor and connector flap are pivoted closed, and a key which when inserted into the enclosures can release the engagement means from the detent to unlock the device.

### DESCRIPTION OF THE DRAWINGS

Embodiments of the present invention will now be described by way of example only with reference to the accompanying drawings in which:

FIG. 1 is a perspective view of a security device for books,

FIG. 2 is a side elevational view of the device in open and closed positions,

FIG. 3 is a cross sectional view along the lines 3-3 of FIG. 1,

FIG. 4 is a cross sectional view along the lines 4-4 of FIG. 3,

FIG. 5 is a an enlarged perspective view of the top of the device illustrating the interlocking of parts of the device,

FIG. 6 is a cross sectional view of the top of the device with the parts of FIG. 5 interlocked,

FIG. 7 is a perspective view of a release key for the device,

FIG. 8 is a side elevational view of an alternate embodiment of the connector flap of the security device, and

FIG. 9 is a top view of the connector flap of FIG. 8.

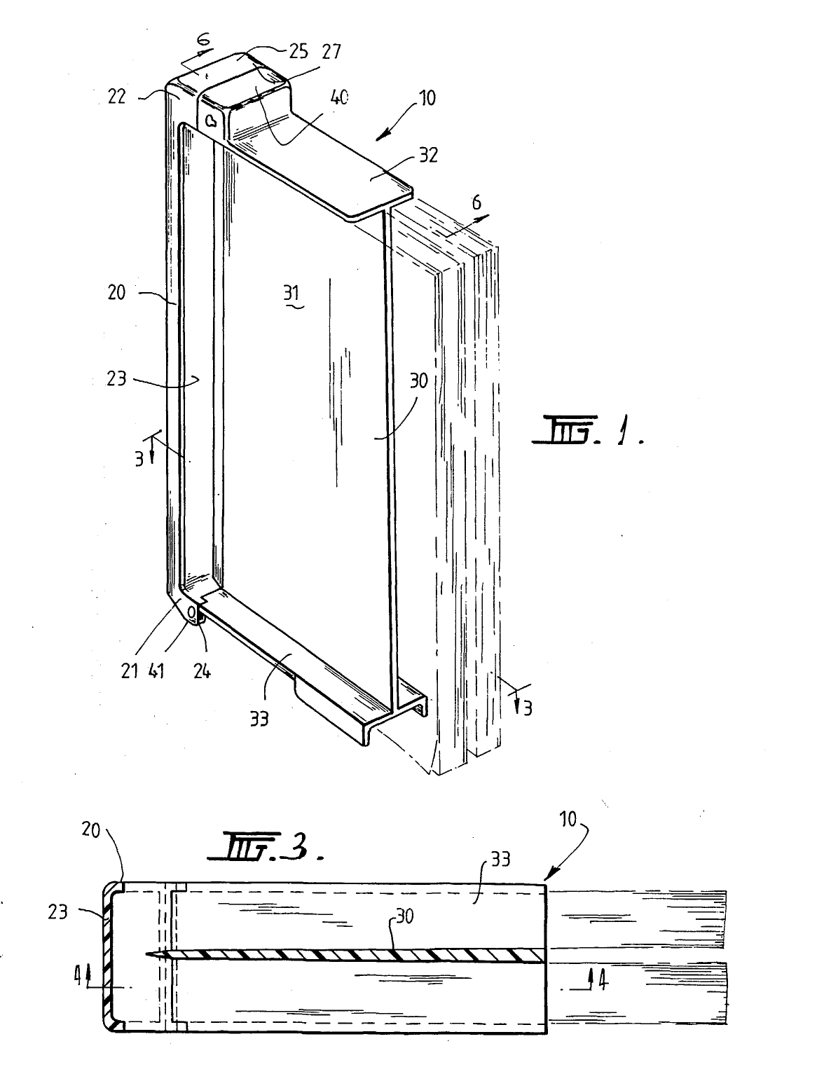

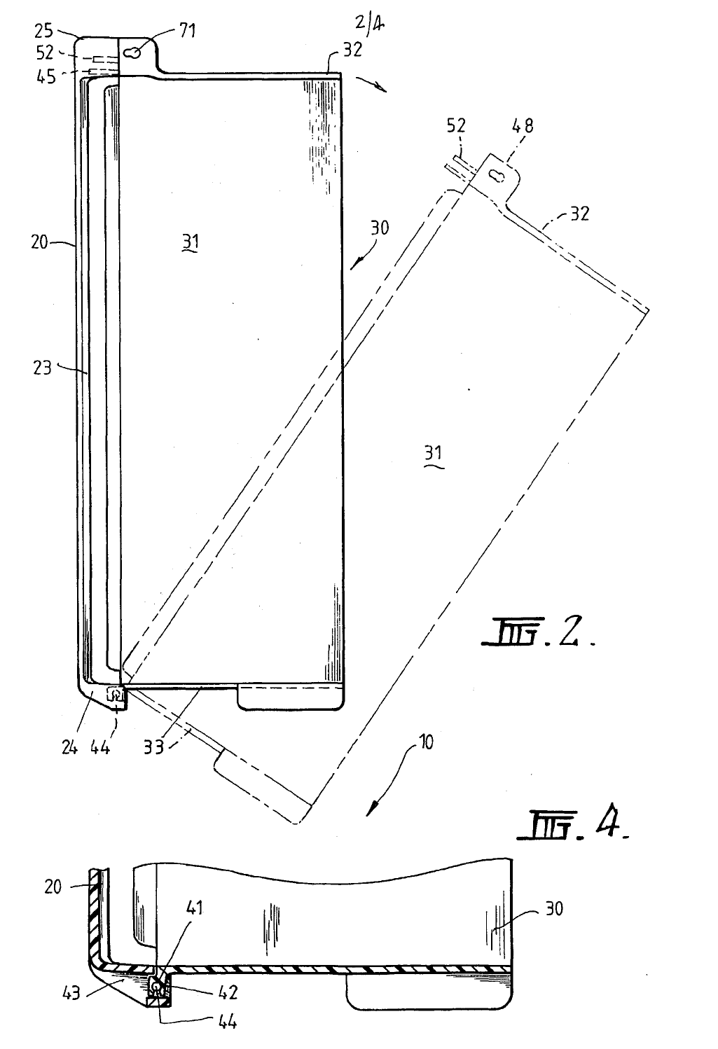

### DESCRIPTION OF THE PREFERRED EMBODIMENT

As shown in the accompanying drawings, a security device 10 for books is preferably moulded in plastics to comprise two main components, namely a receptor 20 and a connector flap 30 that is pivotally secured to one end 21 of the receptor and can be locked to the other end 22 of the receptor through a releasable locking means 50.

The receptor 20 comprises an elongate rectangular strip 23 of plastics with end flanges 24, 25. As shown in FIG. 4, the underside of flange 24 supports one half 43 of a hinge assembly 41 that co-operates with the corresponding half 42 of the hinge assembly 41 formed on an adjacent end of the connector flap 30. A rod 44 extends through the hinge halves 42, 43 to facilitate the pivotal connection of the two components 20, 30. The connector flap 30 has an elongate rectangular surface 31 with inturned longitudinal edges 32, 33. The flap 30 bridges the end flanges 24, 25 of the receptor 20.

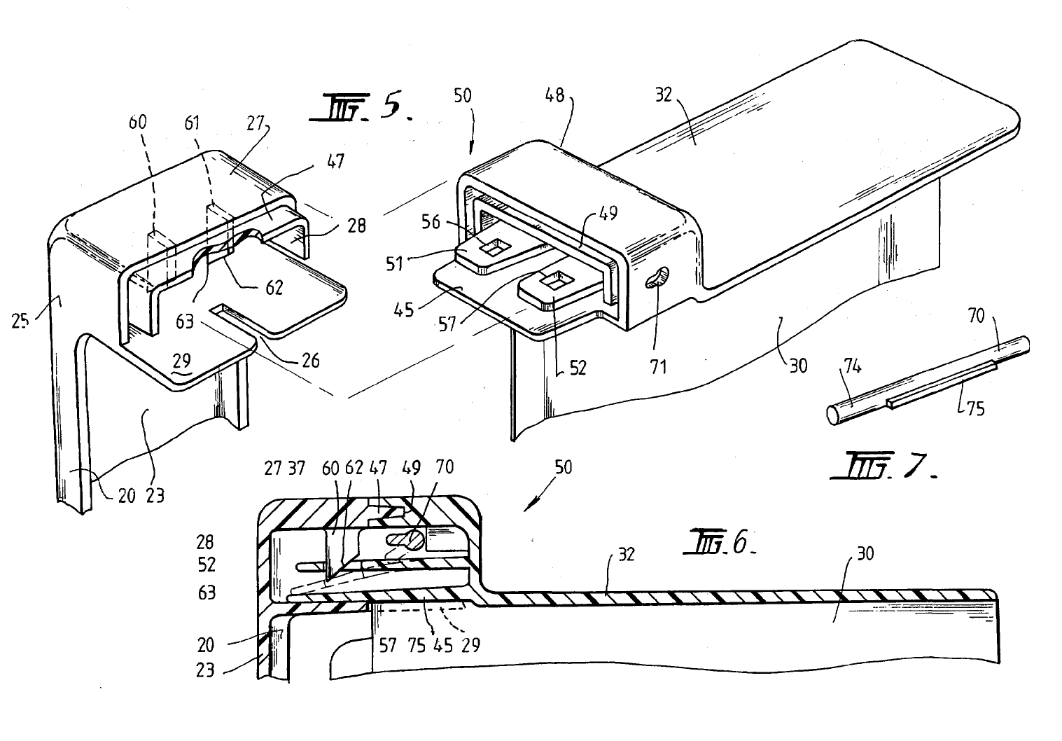

As shown in FIGS. 5 and 6, the flange 25 at the top end of the receptor 20 supports a housing 27 that defines an open enclosure 28 that extends across the end of the flange 25. The base of the housing is defined by a forwardly extending ledge 29 split at its middle by a slot 26. The top of the enclosure 28 has a forwardly projecting location flange 47. The top edge 32 of the connector flap 30 is provided with a similar housing 48 with a peripheral recess 49 that accommodates the location flange 47 of the other housing 27. The housing 48 has a forward projecting ledge 45 that as shown in FIG. 6 slides over the ledge 29 on the housing 27.

The locking means 50 is positioned in the housings 27 and 48 to releasably lock the receptor 20 to the connector flap 30 as shown in FIG. 6. A pair of forwardly projecting parallel spaced apart tabs 51, 52 are formed to extend from an end wall 53 of the housing 48. The tabs 51, 52 are furnished with a rectangular cut-out 56, 57 and can be resiliently depressed towards the ledge 45 of the enclosure 48. The top interior 37 of the housing 27 of the receptor 20 has a pair of spaced apart downwardly extending lugs 60, 61 which are aligned with the cut-outs 56, 57 in the tabs 51, 52. The forward face 62 of each lug is inclined to the vertical and the tip 63 of each lug is shaped to fit into the cut-out 56 or 57.

To close the device 10 the connector flap 30 pivots up so that the forward edges of the housings 27 and 48 interfit and the lugs 60, 61 ride up onto the tabs 51, 52 until the tips 63 slot into the cut-outs 56 and 57. The assembly 10 is then locked and cannot be released without downward displacement of the tabs 51, 52 to release the tips 63 of the lugs. The faces of the housing 27 and 48 abut so that there is no access to the locking means 50.

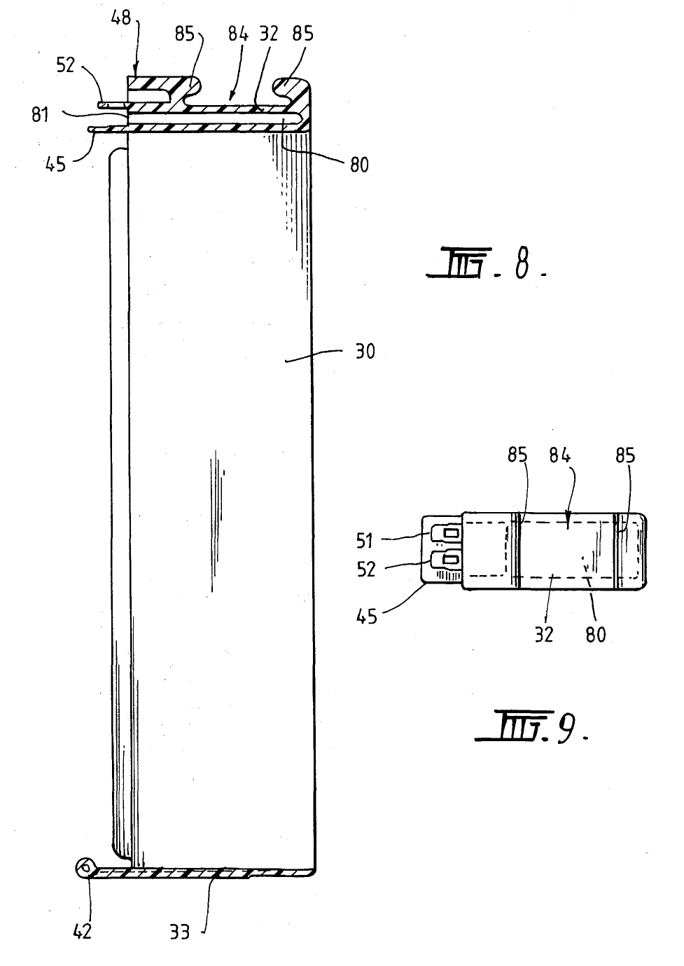

Release is effected by inserting a special release key 70 shown in FIG. 7 through a small elongate aperture 71 in one side wall 72 of the enclosure 48. The key 70 has an elongate cylindrical shank 74 with a laterally extending release flange 75. As shown in FIG. 6, when the shank 74 of the key 70 is fully inserted into the enclosure 24 via the opening 71 in the side wall 72 the release flange 75 extends between the top of the housing 48 and the tabs 51, 52 bridging both tabs 51 and 52 so that axial rotation of the key 70 causes the release flange 75 to bear down on the tabs 51 and 52 and resiliently force them downwards of the enclosure to the position shown dotted in FIG. 6 to thus release the lugs 60, 61.

To use the device the locking means 50 is released and the connector flap 30 pivoted open. The receptor 20 is positioned behind the spine of the book with the planar surface 31 of the flap extending between and in parallel with the middle pages of the book. The flap 30 is then pivoted upwardly to snap closed with the housings 28 and 48 in abutment. The device can only then be removed by use of the special release key 70.

The width of the connector flap 30 is such that it encompasses the spine of most books especially paperbacks. It is however understood that for very large (fat) books, the device would be wider to accommodate the width of the spine of such books. The length of both components is also selected to accommodate the height of most books and it is understood that it would vary with the dimensions of the book.

In another embodiment not illustrated in the drawings, the release key is formed as part of a receptor plate on which the device is located through suitably positioned location means such as projections and apertures. Once the device is located on the receptor plate, the key which is an integral part of the receptor plate can be turned to effect release of the lock. The advantage of this embodiment is that the key is an integral part of a substantial device that would be secured to a work bench to be considerably less likely to be stolen or removed.

Illustrated in FIGS. 8 and 9 is an alternate embodiment of the connector flap of the device which includes a recess in the form of an internal pocket 80 to accommodate an alarm tag. The pocket 80 is located on the underside of top longitudinal edge 32 of housing 48 of the connector flap 30, and substantially extends the length of the edge 32. An opening 81 of pocket 80 is aligned with the opening of housing 48 and faces open enclosure 28 on the receptor 20. In this embodiment, the forward projecting ledge 45 of connector 30 extends outwardly from the base of the pocket 80 rather than housing 48. The position of forwardly extending ledge 29 on the receptor 20 is accordingly adjusted so that it still slides under ledge 45 when the device is locked. The internal pocket 80 accommodates a security alarm tag that can only be accessed through opening 81 when the device is unlocked. Once the device is locked, access to the device is prevented by the abutting housings 28 and 48.

It is envisaged that the security alarm tag itself is a flat rectangular card which once inserted in the pocket would activate an alarm should someone attempt to walk out of a retail outlet with the device past sensor gates.

Also illustrated in FIGS. 8 and 9 is a location means in the form of a locating slot 84 for locating the device on a receptor plate (not shown) as discussed earlier. The locating slot 84 is situated along the top of the connector flap adjacent housing 48 and comprises parallel projecting guides 85 that face each other to form a cross-section that is capable of slidingly receiving a complementarily shaped receptor plate and holding the receptor plate captive. Specifically, in the cross-section the locating slot 84 has a narrow throat formed by the projecting guides 85 and a wider base. The complementarily shaped position on the receptor plate therefore has a wide foot adjacent a narrow throat such that it can slide into locating slot 84 but cannot be perpendicularly removed from the slot 84. The device is mounted on the receptor plate, which is envisaged to be fixed to a surface by sliding the device at the locating slot onto the receptor plate. Once located, a release key on the receptor plate is turned to lock the device to the receptor plate.

The connector half hinge 42 of the hinge assembly 41 is modified in the embodiment illustrated in FIGS. 8 and 9. Rather than protruding downwardly from lower longitudinal edge 33, connector half hinge 42 remains substantially in the same plane as longitudinal edge 33 to form a flat base. This has the advantage of shortening the overall height of the security device and enables the device to stably stand upright.

It is envisaged that the receptor and connector flap, at least, is moulded in plastics and preferably transparent plastics so as to reduce obstruction of printed matter on books to as little as possible.

It will be understood to persons skilled in the art of the invention that many modifications may be made without departing from the spirit and scope of the invention.

1. A security device for books comprising a receptor adapted to fit behind the spine of a book, a connector flap adapted to be secured to the receptor and to locate between and parallel with the pages of the book, and means to lock the connector flap to the receptor to entrap the book.

2. The security device according to claim 1 wherein the connector flap is pivotally secured to one end of the receptor, so that in use the flap can be pivoted away from the receptor to release the book or be pivoted to engage and be locked to the other end of the receptor to entrap the book.

3. The security device according to claim 2 wherein the other end of the receptor and adjacent part of the connector flap have inter-engaging formations that are adapted to snap fit together to lock the connector flap to the receptor.

4. The security device according to claim 3 wherein special release means is required to disengage the formations and unlock the receptor from the connector flap.

5. The security device according to any one of the preceding claims wherein the receptor is an elongate strip that rests against the back of the spine of the book, the connector flap comprising a planar sheet adapted to be secured to the opposite ends of the receptor.

6. The security device according to any one of the preceding claims wherein the receptor and the connector flap are moulded in plastics.

7. The security device according to claim 6 wherein the receptor and the connector flap are moulded in clear plastics.

8. The security device according any one of the preceding claims wherein the means to lock the connector flap to the receptor comprises enclosures formed on the receptor and the connector flap, the enclosures being adapted to abut one another and having resilient engagement means adapted to snap into locked engagement with a fixed detent when the receptor and connector flap are pivoted closed, and a key that when inserted into the enclosures can release the engagement means from the detent to unlock the device.

9. The security device according to claim 7 wherein the key comprises an elongate bar with projections spaced to conform with the spacing of resilient flanges that engage the detent, insertion and rotation of the bar causing the projections to deflect the resilient flanges away from the detent.

10. The security device according to claims 7 or 8 wherein the enclosures have peripheral surfaces that fit together in abutment in a tongue and groove manner.

11. The security device according to any one of the preceding claims wherein the security device includes a recess for receiving a security alarm tag.

12. The security device according to claim 11 when appended to any one of claims 8 to 10, wherein the recess is an elongate pocket located below the enclosure on the connector flap and which pocket is adapted to abut the enclosure on the receptor and close when the receptor and connector flap are locked.

13. The security means according to any one of the preceding claims wherein the device has locating means to locate the device onto a secured member

14. The security means according to claim 13 wherein the locating means is a slot on the connector flap slidingly engageable with a complementary projection on the secured member such that the device is adapted to be slidingly located on the secured member.
